(19) United States
(12) Patent Application Publication
(10) Pub. No.: US 2004/0041402 A1
(43) Pub. Date: Mar. 4, 2004

(54) Drive device especially for a motor vehicle

(76) Inventor: Uwe Dehrmann, Wurzburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/381,402

(22) PCT Filed: Sep. 10, 2001
(86) PCT No.: PCT/EP01/10441

(30) Foreign Application Priority Data
Sep. 22, 2000 (EP) 001207794

(51) Int. Cl. B60K 6/04; B60K 17/02

(52) U.S. Cl. 290/32; 123/179.28; 123/179.25

(57) ABSTRACT

The aim of the invention is to create a simple and especially axially compact way of assembling a drive device comprising an internal combustion engine (1), a starter-generator (2), and an automatic gearbox (3, 4) situated on the output end and having an upstream torque converter (3) which is connected to the crankshaft (1.1) of the internal combustion engine (1) by means of a flexible disc (5). To this end, the starter-generator (2) is arranged on the axial side of the torque converter (3), opposite the internal combustion engine (1).

A motor vehicle which can be operated, at least during limited periods of time, optionally with internal combustion engine only, electric motor only or with combined internal combustion engine and electric motor drive, is known e.g. from DE 43 23 601 A1; the electric machine can also operate as a generator in the form of an electric brake and electrically charge a vehicle battery or, powered by said battery, be used as a starter for the internal combustion engine.

The electric machine and the internal combustion engine act on a common driven shaft leading, in the known case mentioned above, to a manual gearbox; if instead of a manual gearbox an automatic transmission having a torque converter axially preceding a transmission section is used, a known arrangement for normal vehicles powered solely by internal combustion engines is for the internal combustion engine to be coupled to the input side of the torque converter of the automatic transmission via an axially elastic connecting element, in particular a so-called flex plate, essentially extending radially to the engine's crankshaft in order to compensate axial pump loading movements caused by the torque converter. The connecting element, in particular the flex plate, is normally fixed, preferably bolted, to the torque converter by its radially outer end.

The object of the present invention is to create an easily manufacturable and in particular easily assembled, axially compact hybrid-type drive mechanism having an internal combustion engine and an electric machine, in particular a starter/generator, acting on an automatic transmission with torque converter.

The object is achieved by a drive mechanism according to Claim 1; advantageous embodiments of the invention are detailed in the sub-claims.

By disposing the starter/generator on the side facing axially away from the internal combustion engine and the elastic connecting element, in particular the flex plate, i.e. the side of the torque converter facing towards the transmission section, assembly access to the rotationally fixed connection between the axially elastic connecting element and the torque converter is adequately ensured even in the case of comparatively reduced axial installation space, and the radial installation space governed by the external dimensions of the internal combustion engine and of the torque converter can be fully utilized by the starter/generator which can be of correspondingly axially compact design to achieve a specified performance. According to one embodiment, in a manner advantageous for fully utilizing the radial installation space and thereby reducing the overall axial length, a transmission housing cover or a converter cover connecting the transmission section to the internal combustion engine and covering the torque converter is directly provided to support the stator of an electric machine designed as an internal rotor motor.

The invention and further advantageous embodiments of the invention according to features of the sub-claims are explained below with reference to the exemplary embodiment schematically illustrated in the Figure.

A torque converter 3 whose internal construction is known from e.g. the magazine ATZ 88 (1966) 2, pages 81-83 or VDI Reports No. 1175, 1995, pages 281, 282 is axially disposed between an internal combustion engine 1 on the one hand and a starter/generator 2 on the other. The crankshaft 1.1 of the internal combustion engine 1 is rotationally fixed to the radially inner end of an axially elastic connecting element 5, specifically a so-called flex plate, which is in turn rotationally fixed by its radially outer end via an axially mountable bolted connection 5.1 to the cover 3.2 of the torque converter 3 axially adjacent to the internal combustion engine 1; the converter cover 3.2 is rotationally fixed e.g. via a welded joint to the input-side pump shell 3.1 of the torque converter 3 axially adjacent to the starter/generator 2. The rotor 2.3 is attached to said input-side pump shell 3.1 by its rotor shaft in the form of a rotor holder 2.1 as an overhung rotor and therefore rotationally fixed to the crankshaft 1.1 of the internal combustion engine 1 via the converter cover 3.2. The converter cover 3.2 engages with a centering pin 3.21 in a centering receptacle 1.11 of the crankshaft 1.1. With advantageous utilization of the available installation space, the pump housing 6 of the torque converter 3 is provided radially below the rotor 2.3 with a pump bearing 6.2 and a pump gasket 6.3 to a pump hub 6.1.

The transmission section 4 of the automatic transmission 3;4 disposed axially outside on the side of the starter/generator 2 facing away from the torque converter 3 is connected to the internal combustion engine 1 via a transmission housing cover 4.1 or a converter cover covering the starter/generator 2 and the torque converter 3. In an advantageous manner for easy and space-saving installation, the transmission housing cover 4.1 or converter cover is implemented as a direct support for the stator section 2.2 of the starter/generator 2.

The drive mechanism according to the invention may be summarized as follows: To ensure easy and in particular axially compact assembly of a drive mechanism comprising an internal combustion engine 1 and a starter/generator 2 as well as an output-side automatic transmission 3;4 preceded by a torque converter 3 connected to the crankshaft 1.1 of the internal combustion engine 1 via a flex plate 5, the starter/generator 2 is disposed on the axial side of the torque converter 3 facing away from the internal combustion engine 1.

1. Drive mechanism, in particular for a motor vehicle
having an internal combustion engine (1) with a driven shaft (1.1), preferably a crankshaft;
having a starter/generator (2), particularly in the form of an asynchronous machine, which can be connected by its rotor (2.3) to the driven shaft (1.1) of the internal combustion engine (1);
having an output-side automatic transmission (3;4) with a transmission section (4) and a torque converter (3);
having the starter/generator (2) disposed on the side of the torque converter (3) facing axially away from the internal combustion engine.

2. Drive mechanism according to claim 1
having a rotationally fixed coupling between an input-side cover (3.1) of the torque converter (3) and the driven shaft (1.1) of the internal combustion engine (1) via an axially elastic connecting element (5), in particular a radially elongated flex plate, on the side of the torque converter (3) facing axially towards the internal combustion engine (1).

3. Drive mechanism according to claim 1 and/or 2
having a rotationally fixed coupling between the rotor (2.3) and an input-side pump bowl (3.1) of the torque converter (3) on the end face of the torque converter (3) facing axially away from the rotationally fixed coupling between the torque converter (3) and the internal combustion engine (1).

4. Drive mechanism according to at least one of claims 1-3
having a rotationally fixed coupling between the torque converter (3) and the elastic connecting element (5), in particular the flex plate, in its radially outer end region.

5. Drive mechanism according to at least one of claims 1-4
having an axial elongation of the starter/generator (2) between the torque converter (3) and the transmission section (4), and having a radial elongation of the starter/generator (2), in particular of its stator (2.2), extending in the case of an internal rotor electric motor into the area of the rotationally fixed coupling between the elastic connecting element (5), in particular the flex plate, and the torque converter (3).

6. Drive mechanism according to at least one of claims 1-5
having the transmission section (4) of the automatic transmission (3;4) supported on the internal combustion engine (1) by means of a transmission housing cover (4.1) radially and axially covering the torque converter (3).

7. Drive mechanism according to claim 6
having a transmission housing cover (4.1) designed as a stator holder for direct accommodation of the stator (2.2) of the starter/generator (2).
